(19) United States
(12) Patent Application Publication
(10) Pub. No.: US 2007/0055480 A1
(43) Pub. Date: Mar. 8, 2007

(54) System and method for self-diagnosis in a controller

(76) Inventors: Hiromichi Endoh, Hitachi (JP); Tsutomu Yamada, Hitachinaka (JP); Naoya Mashiko, Hitachiota (JP); Takashi Umehara, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/514,273

(22) Filed: Sep. 1, 2006

(30) Foreign Application Priority Data
Sep. 2, 2005 (JP) 2005-254863

(51) Int. Cl. G21C 17/00

(52) U.S. Cl. 702/183

(57) ABSTRACT

A self-diagnosis system of a processor capable of realizing a sufficiently high processing ability for control tasks is provided without deteriorating reliability of safety controls even in complex diagnostic techniques. The self-diagnosis system is equipped with a diagnostic target area allocator for allocating a non-active area within a memory as a diagnosis-ready area, which is not used in a control task under execution by a main processor in an independent manner from the main processor; and a diagnostic executor for executing a diagnosis based upon a predetermined sequence in an independent manner from the main processor. In the self-diagnosis system, a diagnostic target area segmented from the diagnosis-ready area is selected, and a diagnosis of the selected diagnostic target area is carried out in each of diagnostic cycles by the diagnostic executor.

### BACKGROUND OF THE INVENTION

The present invention generally relates to a self-diagnosis system of a controller and a self-diagnosis method thereof. More specifically, the present invention is directed to controller self-diagnosis system and method capable of suitably diagnosing safety control functions in a controller to which safety control functions are required.

In process facilities having potentially higher risks known as nuclear plants and chemical plants, both passive measures and active measures are conducted in order to reduce adverse influences given to workers and peripheral environments in emergency cases. As the passive measures, guard/protection facilities such as partition walls are conducted, whereas as the active measures, safety apparatus such as emergency shutdown systems are employed. Among these measures, such control means as safety apparatus have been conventionally realized by electromagnetic/mechanical means, for instance, relays. However, very recently, since techniques utilized in programmable control appliances have been actively developed, such a need for using these techniques as control means for safety control systems is increased. The programmable control appliances are typically known as PLCs (Programmable Logic Controllers).

IEC (International Electrotechnical Commission) 61508 is an international standard issued in correspondence with the above-explained trends, while IEC 61508 defines requirements for such a case that electrical/electronic/programmable electronic apparatus are utilized as a portion of safety control systems (refer to IEC 61508 “Functional Safety of Electrical/Electronic/Programmable Electronic safety related systems”). In IEC 61508 , SILs (Safety Integrity Levels) have been defined as levels of abilities of safety control systems, and requirement items corresponding to levels from 1 to 4 are defined. The higher SIL becomes, the larger the degree becomes which is capable of lowering a potential risk owned by a process facility. In other words, this SIL implies that when an abnormal condition of a process facility is detected, how degree a predetermined safety control operation can be firmly carried out.

Even if a safety control apparatus becomes inactive under the normal operating status, when an abnormal event happens to occur in a process facility, the safety control apparatus is required to become immediately active. To this end, it is important for such a safety control apparatus that the safety control apparatus always performs a self-diagnosis so as to continuously check the own sound characteristic. Also, in a safety control system requiring a high SIL, a self-diagnosis must be carried out over a wide range in high precision in order to minimize probability at which the safety control system is not operable due to an undetected failure.

In IEC 61508, self-diagnostic technical methods are introduced which are applied to respective sorts of structural components which constitute a safety control apparatus, and validities for the respective technical methods are represented in the forms of diagnostic coverages. A diagnostic coverage indicates a ratio of detectable failure when a relevant technical method is employed to all failures occurred in each of structural elements. For example, the diagnostic technical method “Abraham” of a RAM describes that a diagnostic coverage of 99% in maximum can be argued in IEC 61508, while this diagnostic technical method has been proposed in R. Nair, S.M. Thatte, J. A. Abraham “Efficient Algorithms for Testing Semiconductor Random-Access Memories”, IEEE transaction computer C-27(6), pages 572 to 576 in 1978.

The memory diagnosing method of Japanese Patent No. 3171364 has disclosed a method for operating a memory diagnostic program on an OS (Operating System) having a virtual address handling ability. The memory diagnostic program acquires memory allocation information such as a page table and an address translation table so as to form a map of memories which are mounted on the system, and performs a diagnosis in accordance with this map. In addition, as to such a memory page which is not managed by the page table, since the diagnostic program performs a diagnosis by employing an access based upon a physical address, all of memory areas mounted in the system may be covered.

JP-A-2000-163322 has disclosed both a control method of a memory patrol and a realizing circuit arrangement thereof. In the memory patrol control method, while under use status/empty status for each of memory regions are acquired time to time, a frequency of patrol with respect to a memory area under empty status is decreased, so that a patrol efficiency in a system for mounting a large capacity of memories can be increased.

In a safety control system which requires a high SIL, a self-diagnosis must be always carried out in parallel to a safety control operation which should be originally performed. On the other hand, in order to achieve a high diagnostic coverage, a high precision diagnostic technical method must be employed. However, if such a high precision diagnostic technical method and a safety control operation are carried out at the same time, then there are some possibilities that an adverse influence may be given to the safety control operation which constitutes the original purpose of the safety control system.

For instance, in the diagnostic technical idea described in the above-explained IEEE transaction computer C-27(6), since the test is performed by considering the influences as to not only the memory cells corresponding to the respective words, but also the influences as to the adjoining memory cells and the cells in the same row address, the complex memory access patterns must be conducted.

The conventionally executed memory patrol corresponds to a simple method, and even when this memory patrol is executed by a control-purpose main processor, there is a very few influence given to a control task. However, in such a case that the above-explained complex diagnostic technical method is employed, if this complex diagnostic technical method is mounted as a task on the main processor, then the process ability of the main processor is excessively consumed. As a result, there is a risk that the original control task cannot secure the sufficient processing ability.

In the memory diagnostic method disclosed in the above-described Japanese Patent No. 3171364, since the control-purpose main processor itself executes the memory diagnostic program, the main processor cannot execute the original control task while the diagnostic process operation of the memory is carried out.

JP-A-2000-163322 does not describe the interconnection between the memory access by the originally executed control task and the memory patrol executed by the patrol control circuit. As a consequence, in such a case that a memory area which is required to be accessed by the originally executed control task is under the patrol by the patrol control circuit, such a delay in the process operation for the originally executed control task cannot be avoided.

### SUMMARY OF THE INVENTION

A self-diagnosis system, according to an aspect of the present invention, is featured by that in a self-diagnosis system of a controller which is equipped with a memory connected to a system bus; a main processor connected to the system bus, for executing a control task by employing the memory; and an input/output device and/or a communication apparatus, which is connected to the system bus and is employed so as to input/output a signal by the main processor; the self-diagnosis system of the controller is comprised of: a diagnostic target area allocator for allocating a structural element of the controller as a diagnosis-ready area, which is not used in a control task under execution by the main processor, in an independent manner from the main processor; and a diagnostic executor for executing a diagnosis based upon a predetermined sequence with respect to the diagnosis-ready area allocated by the diagnostic target area allocator in an independent manner from the main processor.

A self-diagnosis system, according to another aspect of the present invention, is featured by that a self-diagnosis system of a controller which is equipped with a memory connected to a system bus; a main processor connected to the system bus, for executing a control task by employing the memory; and a diagnosing apparatus connected to the system bus, for diagnosing said memory in an independent manner from the main processor; in which the diagnosing apparatus is comprised of: a diagnostic target area allocator for allocating a memory area of the memory as a diagnosis-ready area, which is not used in a control task under execution by the main processor; and a diagnostic executor for executing a diagnosis based upon a predetermined sequence with respect to the diagnosis-ready area.

In accordance with a preferable embodiment mode of the present invention, the diagnostic executor is provided in an independent manner from the control-purpose main processor. As a result, the main processor can be released from the self-diagnostic process operation of the controller. As a consequence, the main processor can realize the sufficiently high process ability with respect to the originally executed control task, and can perform the self-diagnosis without interfering an access operation issued from a control task under execution, so that the originally executed control task is not delayed.

As a result, while the self-diagnosis can be realized in high precision and the safe characteristic can be improved, the original control processing ability can be improved.

Other objects, features and advantages of the invention will become apparent from the following description of the embodiments of the invention taken in conjunction with the accompanying drawings.

### BRIEF DESCRIPTION OF THE DRAWINGS

FIG. 1 is an entire structural diagram for schematically showing a self-diagnosis system of a controller, according to an embodiment 1 of the present invention.

FIG. 2 is a diagram for illustratively representing a data arranging structure in a memory 40 employed in the self-diagnosis system according to the embodiment 1 of the present invention.

FIG. 3 is a flow chart for describing process flow operations of a diagnostic target area allocator 31 employed in the self-diagnosis system of the embodiment 1.

FIG. 4 is a flow chart for explaining process flow operations of a diagnostic executor 32 employed in the self-diagnosis system of the embodiment 1.

FIG. 5 is an explanatory diagram for explaining interconnection operations of the respective units employed in the self-diagnosis system of the embodiment 1.

FIG. 6 is an entire structural diagram for schematically showing a self-diagnosis system of a controller, according to an embodiment 2 of the present invention.

FIG. 7 is an entire structural diagram for schematically showing a self-diagnosis system of a controller, according to an embodiment 3 of the present invention.

Other objects and features according to the present invention will become apparent in the below-mentioned embodiments.

### DETAILED DESCRIPTION OF THE INVENTION

Referring now to drawings, various embodiments of the present invention will be explained.

(Embodiment 1)

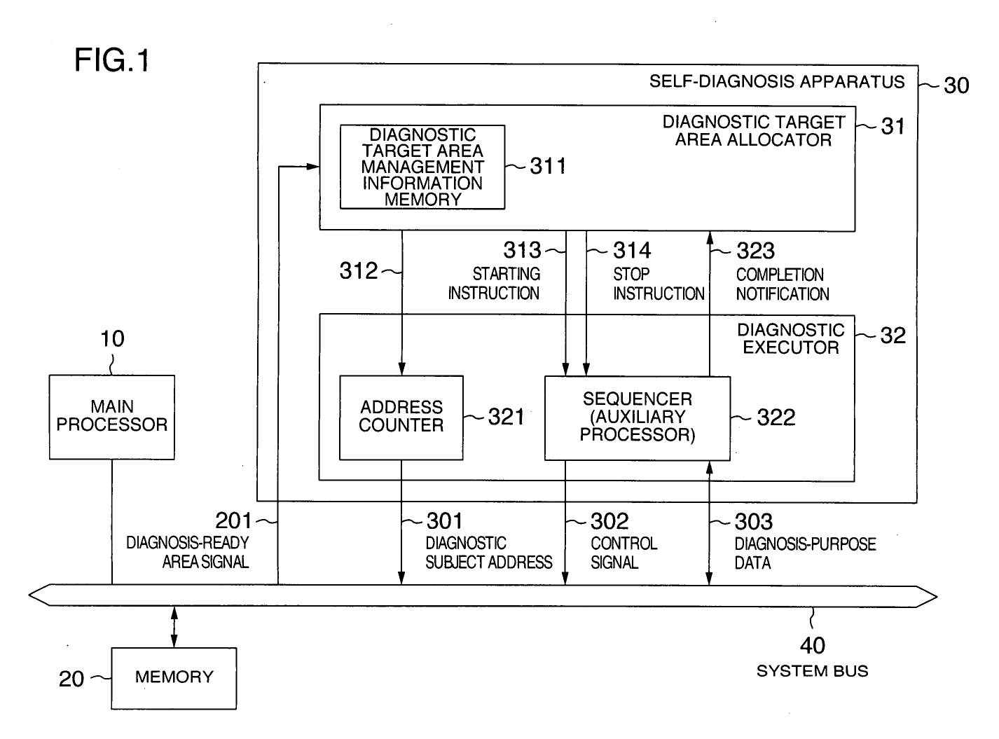

FIG. 1 schematically indicates an entire arrangement as to a self-diagnosis system of a controller, according to an embodiment 1 of the present invention. In this embodiment 1, a description is made of such a case that the self-diagnosis system executes a self-diagnosis as to a memory as a target.

A controller is equipped with a control-purpose main processor 10, a memory 20, and a self-diagnosis apparatus 30. These structural elements are connected to each other by employing a system bus 40. As the system bus 40, in addition to a simple processor bus, normally employed techniques such as a PCI (Peripheral Component Interconnect) bus, and the like may be properly selected.

The self-diagnosis apparatus 30 is constituted by a diagnostic target area allocator 31 and a diagnosis executor 32.

The diagnosis target area allocator 31 receives a diagnosis-ready area signal 201 from an OS (Operating System) stored in the memory 20, and stores the received diagnosis-ready area signal 201 in a diagnostic target area management information storage means 311, and also, applies an initial diagnostic address 312, a diagnosis starting instruction 313, and a diagnosis stop instruction 314 with respect to the diagnostic executor 32. Further, the diagnostic target area allocator 31 selects a diagnostic target “page” for each of diagnostic cycles, and instructs this diagnostic target “page” with respect to the diagnosis executor 32. Although a size of a diagnostic target “page” in one diagnostic cycle may be arbitrarily determined, a “page” which is employed in memory management by the OS is also used as a diagnostic target “page” for 1 diagnostic cycle. A size of a “page” is normally equal to 1 Kbyte, 4 Kbytes, 16 Kbytes, and the like.

The diagnostic executor 32 is arranged by an address counter 321 and a sequencer 322. The address counter 321 receives the initial diagnostic address 312 from the diagnostic target area allocator 31 when a diagnostic cycle is commenced, and accesses the diagnostic target address 301 of the memory 20 via the system bus 40 during a diagnosis. As a consequence, the sequencer 321 executes a diagnosis in accordance with a predetermined diagnostic sequence as to a diagnostic target address 301 within the memory 20, and transmits/receives a control signal 302 and diagnosis-purpose data 303 between the memory 20 and the own sequencer 322. As to the diagnostic sequence in this case, a proper sequence may be employed in response to necessary diagnostic precision.

It should be understood that the sequencer 322 may be constructed as a dedicated hardware logic, or may be alternatively arranged in such a manner that a predetermined diagnostic sequence is executed by performing a software process operation by utilizing an auxiliary processor.

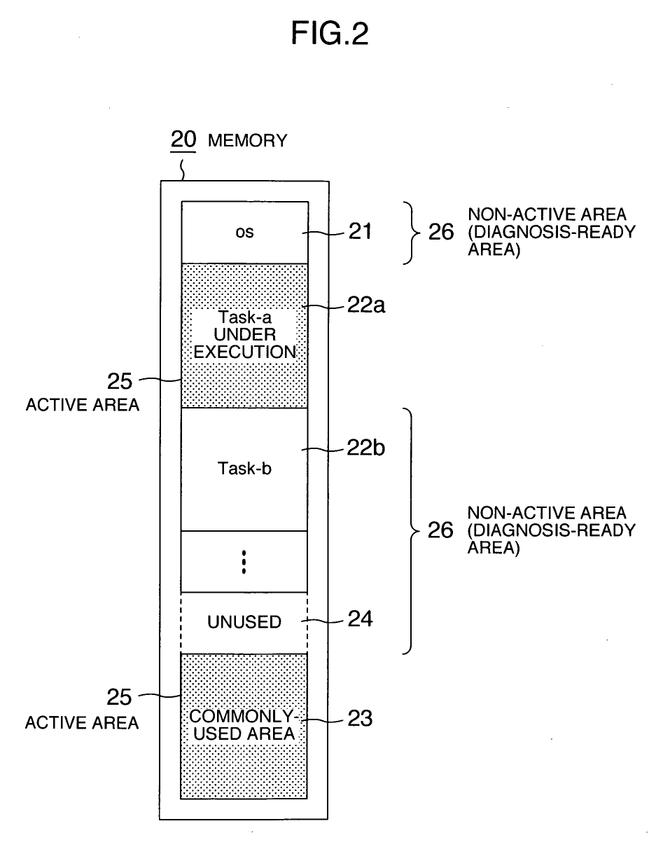

FIG. 2 is a diagram for illustratively showing an arrangement structure as to data stored in the memory 20 in the embodiment 1. That is, an operating system (OS) 21, and control tasks 22a, 22b - - - , are arranged in the memory 20. In a certain case, a commonly-used area 23 which is used to a plurality of tasks, and a non-used are 24 which is not used in any task are present in the memory 20. The control tasks 20a, 20b, - - - are executed by the main processor 10 under management of the OS 21.

When such a control task under execution is the control task 22a, both the area of the control task 22a under use and the commonly-used area 23 will be referred to as an “active area 25”, whereas the OS area, the areas of the control tasks 22b, - - - , which correspond to unused areas other than the previous areas, and the unused area 24 will be referred to as a “non-active area 26.” This non-active area 26 is set to a diagnosis-ready area by the OS 21. For instance, while “Task-a” is under execution, a diagnosis with respect to the above-explained active area 25 should not be executed. Accordingly, the non-active area 26 obtained by removing the active area 25 from all areas of the memory 20 is defined as a diagnosis-ready area.

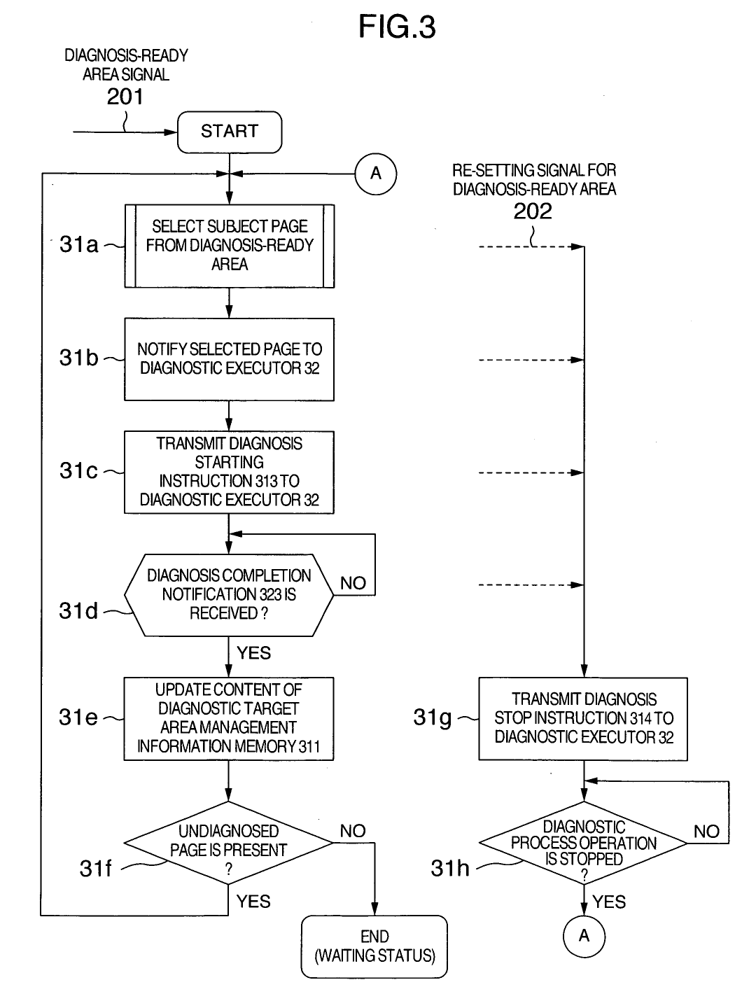

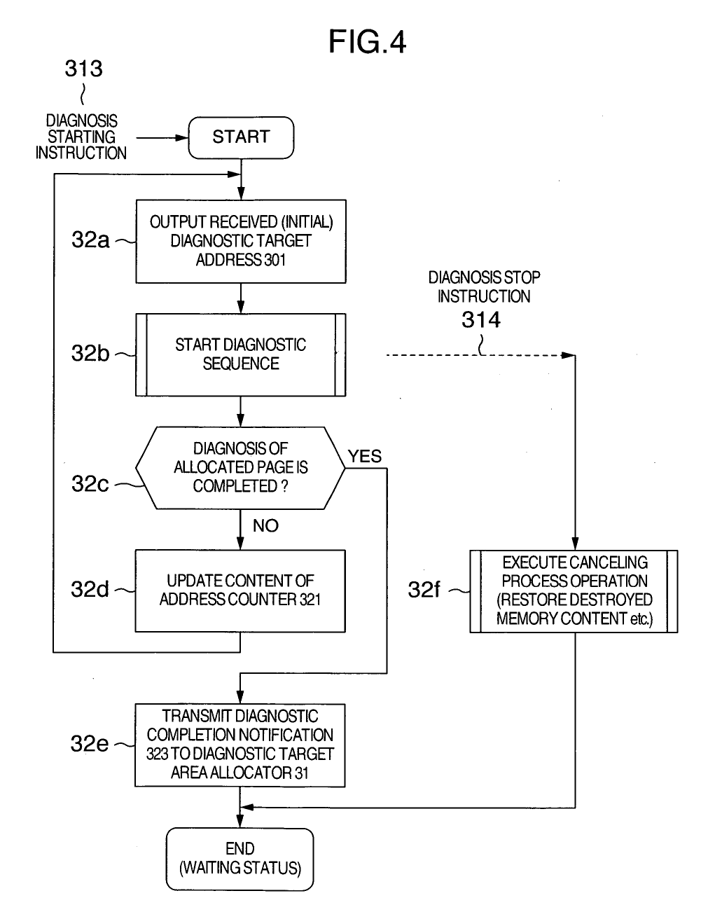

FIG. 3 is a flow chart for explaining process flow operations of the diagnostic target area allocator 31 according to the embodiment 1 of the present invention. The diagnostic target area allocator 31 starts operations by receiving a diagnosis-ready area signal 201 from the OS 21. In the beginning, in a step 31a, the diagnostic target area allocator 31 selects one of undiagnosed pages from the set diagnosis-ready area. Next, in a step 31b, the diagnostic target area allocator 31 notifies an address of the selected diagnostic target “page” to the diagnostic executor 32 as an initial diagnostic address 312. Furthermore, in a step 31c, the diagnostic target area allocator 31 transmits a diagnosis starting instruction 313 to the diagnostic executor 32 in such a manner that the diagnostic executor 32 starts a diagnosis from the previously notified initial diagnostic address 312. As a result, a new diagnostic cycle with respect to the diagnostic target page is commenced by the diagnostic executor 32. Process flow operations of the diagnostic executor 32 will be explained later with reference to FIG. 4.

After the diagnostic cycle is commenced, the diagnostic target area allocator 31 waits until a diagnosis completion notification 323 is received from the diagnostic executor 32 in a step 31d. In the case that the diagnosis completion notification 323 is received, the content of the diagnostic target are management information storage means 31 is updated based upon the information as to the pages whose diagnosis is completed in a step 31e. Finally, the diagnostic target area allocator 31 judges as to whether or not an undiagnosed page is left in the given diagnosis-ready area at a step 31f. In such a case that the undiagnosed page is left, the process operation is returned to the step 31a, and then, the process operations defined from the step 31a to the step 31f are repeatedly carried out with respect to this undiagnosed page. In the case that the undiagnosed page is not left, the diagnostic target area allocator 31 waits until a new diagnosable area is set.

It should be noted that as previously explained, the information as to the area whose diagnosis has been completed is held in such a form by updating the storage content of the diagnostic target area management information storage means 311, and is re-initialized at a time when diagnosises have been accomplished in all of the areas of the memory 20, and then, is returned to an undiagnosed condition. As a result, equal chances of the diagnoses can be secured over the entire area.

On the other hand, there are certain possibilities that while the diagnostic target area allocator 31 is executing the above-explained steps, a re-setting signal 202 of a diagnosis-ready area is outputted from the OS 21 in an asynchronous manner. Since this re-setting signal 202 may be received at an arbitrary time instant while the above-explained steps are executed, these signal receptions are indicated by arrows of broken lines along a right direction in FIG. 3. In the case that this re-setting signal 202 for the diagnosis-ready area is outputted, the diagnostic target area allocating means 31 transmits a diagnosis stop signal 314 to the diagnostic executor 32 in order to interrupt the previously-executed process operation in a step 31g. Next, in a step 31h, after an end of the present diagnostic cycle is confirmed, the process operation is again returned to the step 31a in which the diagnostic target area allocator 31 commences a diagnosis with respect to an undiagnosed page which is present.

FIG. 4 is a flow chart for explaining diagnostic process operations executed by the diagnostic executor 32 according to the embodiment 1 of the present invention. As previously explained with reference to FIG. 3, since the sequencer 322 receives the diagnosis starting instruction from the diagnostic target area allocator 31, a diagnostic cycle is commenced. In a step 32a, a diagnostic subject address 301 is outputted from the address counter 321 to the system bus 40. Next, in a step 32b, a diagnosis with respect to the subject address is commenced by the main body of the sequencer 322. In this step 32b, a read and write operation is executed with respect to the memory 20. In a step 32c, when one diagnostic sequence is ended, the diagnostic executor 33 checks the address counter 321. In the case that the diagnosis for 1 page from the initial diagnostic address 312 has not yet been accomplished, the diagnostic executor 32 increments a count value of the address counter 321 in a step 32d, and the process operation is returned to the step 32a in which the diagnostic executor 32 executes the diagnosis. On the other hand, in the case that the diagnosis for 1 page from the initial diagnostic address 312 has been accomplished, the process operation is advanced to a step 32e in which the diagnostic executor 32 sends a diagnosis completion notification 32 with respect to the diagnostic target area allocator 31, and accomplishes the diagnostic cycle to be brought into a waiting state.

Also, in such a case that the diagnostic executor 32 receives a diagnosis stop instruction 314 from the diagnostic target area allocator 31 at an arbitrary time instant in a half way of the diagnostic sequence, the diagnostic executor 32 executes a diagnosis canceling process operation at a step 32f, and then, accomplishes the diagnostic cycle after the destroyed memory content is restored according to necessity.

Next, an interconnection operation in which a diagnosis is not carried out with respect to such a memory area which is probably accessed by a control task will now be described, while the interconnection operation constitutes an important aspect of the present invention.

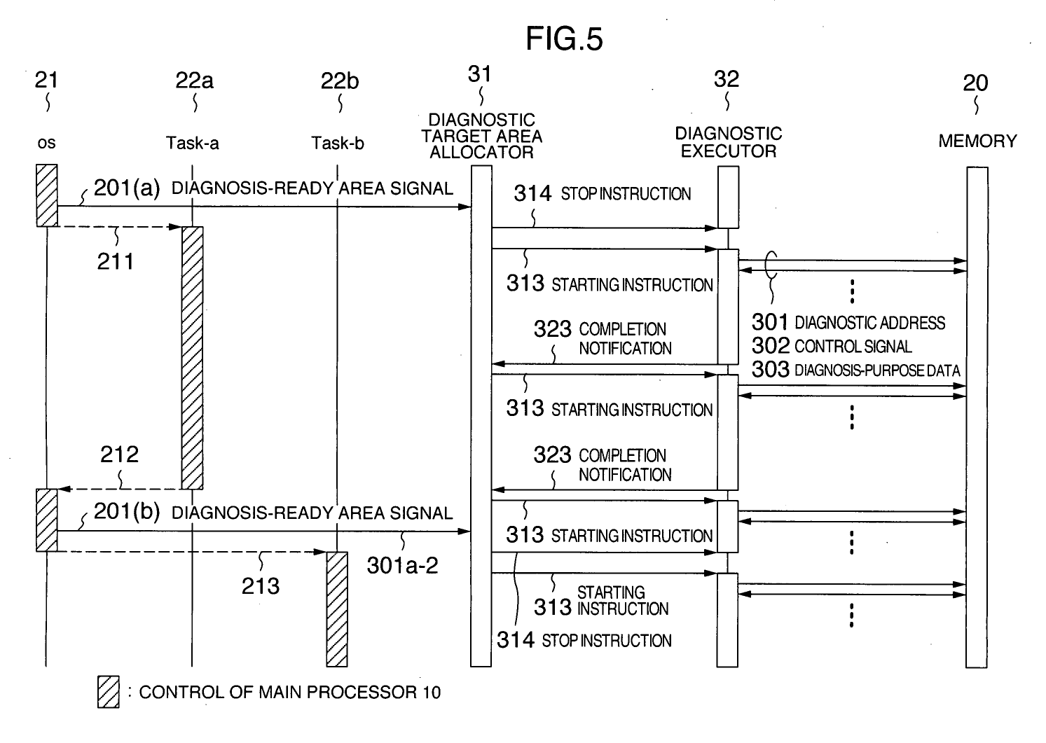

FIG. 5 is a timing diagram for representing an interconnection operation between both the diagnostic target area allocator 31 and the diagnostic executor 32, and both the OS 21 and the control tasks “Task-a” and “Task-b.” In this interconnection operation example, the following assumption is made: That is, a task switching operation is carried out from such a task which has been so far executed to the control task Task-a, the control task Task-a performs the control operation for the time being, and thereafter, a task switching operation occurs from the control task Task-a to the control task Task-b.

First of all, the OS 21 has prepared a task switching operation required as the OS (Operating System), and thereafter, determines a diagnostic-ready area in order not to give an influence to the execution of the control task Task-a. As previously explained with reference to FIG. 2, the OS 21 firstly determines such a diagnosis-ready area which corresponds to the control task Task-a. Normally, since the OS 21 performs management of control tasks, this OS 21 owns management information (not shown) related to memory areas which are occupied by the respective control tasks. The OS 21 judges that both the storage area 22a of the control task Task-a and the commonly-used area 23 as such an area which is occupied by the control task Task-a by employing this management information, and then defines this occupied area as the active area 25. Since a diagnosis with respect to the active area 25 should not be executed while the control task Task-a is being executed, the OS 21 defines the non-active area 26 as a diagnosis-ready area, and this non-active area 26 is obtained by removing the active area 25 from all of the areas of the memory 20.

As previously explained in the beginning portion as to FIG. 5, the OS 21 transmits a diagnosis-ready area signal 201(a) with respect to the diagnostic target area allocator 31 before the OS 21 performs the task switching operation from the task (not shown) which has been so far executed to the control task Task-a. As a result, the diagnostic target area allocator 31 is initiated, and thus, starts to control the diagnostic executor 32 in accordance with the previously explained operation. The diagnostic executor 32 executes a diagnostic sequence with respect to the non-active area 26 in accordance with a diagnostic instruction issued from the diagnostic target area allocator 31. The OS 21 transfers a control of the main processor 10 to the control task Task-a in a step 211 indicated by an arrow of a broken line, and then, the control operation by the control task Task-a is commenced.

Next, when the task switching operation from the control task Task-a to the control task Task-b occurs, the control of the main processor 10 is once returned to the OS 21 in a step 212. After the OS 21 has prepared the task switching operation in a similar manner to the above-explained manner, the OS 21 transmits another diagnosis-ready area signal 201(b) to the diagnostic target area allocator 31 in order that the OS 21 presently sets a diagnosis-ready area corresponding to the control task Task-b. The diagnosis-ready area corresponding to the control task Task-b corresponds to such an area which is obtained by removing both the storage area 22b of the control task Task-b itself and the commonly-used area 23 from all of the areas of the memory 20. After the diagnosis-ready area has been again set with respect to the diagnostic target area allocator 31, in a step 213, the OS 21 transfers the control of the main processor 10 to the control task Task-b, so that a control operation by the control task Task-b is commenced.

In accordance with the previously described embodiment 1, the memory diagnosis can be carried out while escaping such a memory area which may be probably accessed by the control task under execution on the main processor 10. As a consequence, it is possible to avoid a delay of executions which occurs since the control task accesses the memory area under diagnose. Both the safe characteristic and the processing capability of the control operation by the controller can be secured at the same time.

(Embodiment 2)

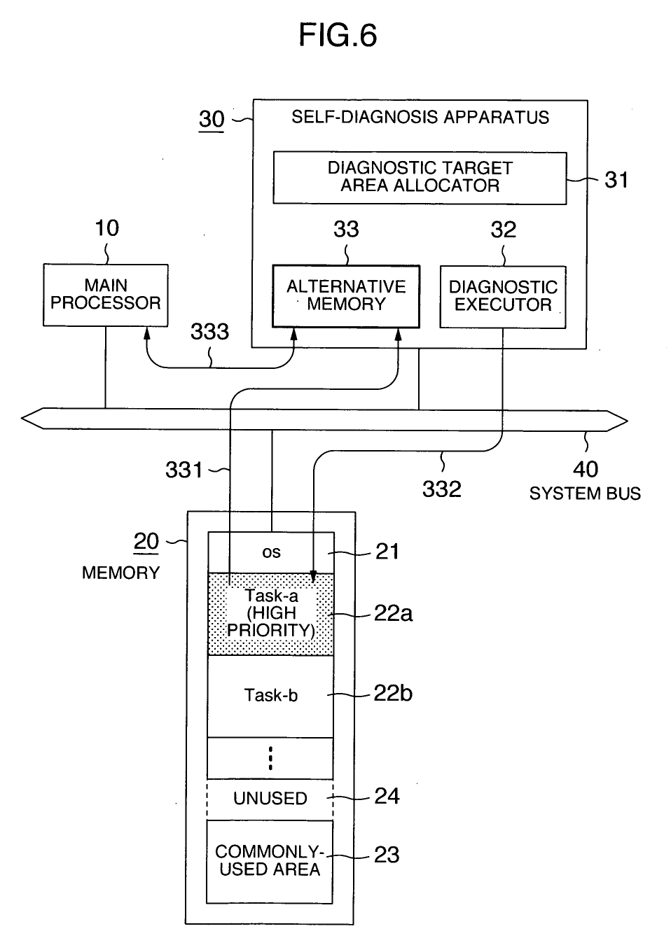

FIG. 6 is an entire structural diagram for indicating a self-diagnosis system of a controller according to an embodiment 2 of the present invention. A self-diagnosis apparatus 30 is provided with an alternative memory 33 in addition to a diagnostic target area allocator 31 and a diagnostic executor 32. Both the diagnostic target area allocator 31 and the diagnostic executor 32 are equivalent to those of the embodiment 1 shown in FIG. 1. The alternative memory 33 is such a memory for saving data of a designated area within the memory 20. The saved data may be accessed from the main processor 10 similar to the memory 20.

While a control task “Task-a” stored in a memory area 22a owns a very high execution priority, as compared with those of other control tasks, the control task “Task-a” has been brought into such an execution mode that this control task “Task-a” substantially always has a control of the main processor 10. In such a case, in accordance with the diagnosis system as explained in the embodiment 1, there is a small chance that the diagnosis executor 32 is allowed to diagnose a memory area occupied by the control task Task-a, and the diagnosis executor 32 cannot sufficiently execute the diagnosis.

As a consequence, in accordance with this embodiment 2, in the case that the OS 21 judges that the control task Task-a corresponds to such a task having a high execution priority and there is a small chance that an area occupied by the control task Task-a is diagnosed, the OS 21 saves a memory content of a memory area 22a occupied by the control task Task-a into the alternative memory 33 in a step 331. Under this condition, the OS 21 sets the memory area 22a corresponding to the saved source to the diagnostic target area allocator 31 as a diagnosis-ready area, and a diagnosis with respect to the memory area 22a is commenced in a step 332. Subsequently, in a step 333, for a time period during which the diagnosis with respect to the memory area 22a is accomplished, an access operation with respect to the data stored in the memory area 22a is substituted by the access operation with respect to the data saved in the alternative memory 33. Also, as to the commonly-used area 23, the data may be saved to the alternative memory 33 so as to perform a diagnosis in a similar sequential operation.

In this case, it is preferable to arrange the alternative memory 33 in such a way that the access operation is automatically switched to the alternative memory 33 by the main processor 10 by designating the address of the memory area 22a. In this alternative case, in both the OS 21 and the software of the control tasks 22a, 22b, - - - , the alternative memory 33 may be utilized without taking a specific action.

In accordance with the above-explained embodiment 2, in the case that there is such a task which is executed in a high frequency, a chance for a diagnosis can also be given to a memory area which is occupied by this task, the chances for the diagnoses with respect to the memory areas can be made equal to each other.

(Embodiment 3)

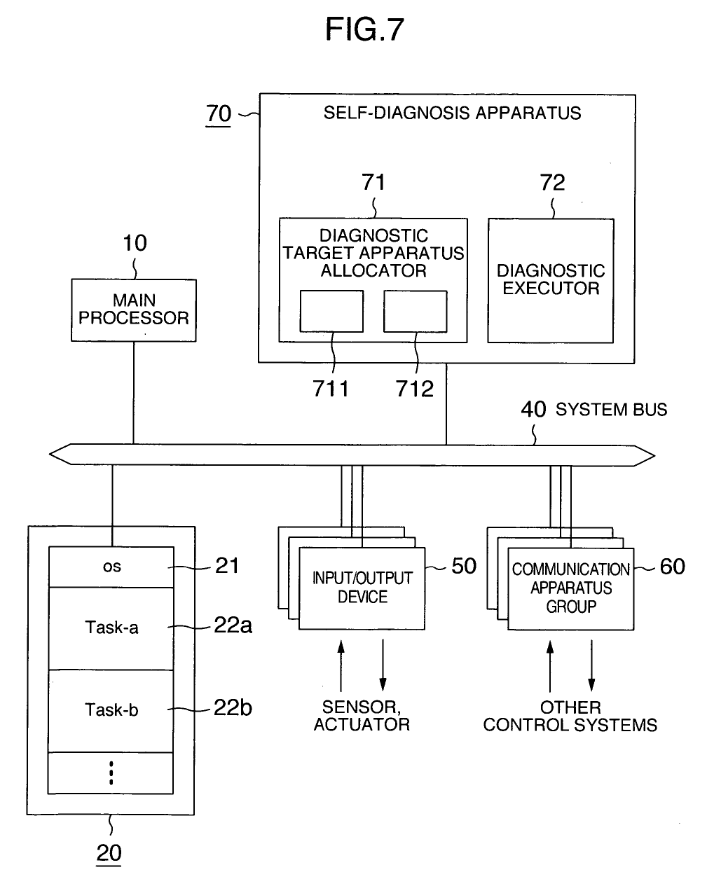

FIG. 7 is an entire structural diagram for indicating a self-diagnosis system of a controller according to an embodiment 3 of the present invention. In this embodiment 3, a description is made of such a case that an input/output device and a communication apparatus of controller are also diagnosed as a diagnostic subject.

The controller is equipped with a main processor 10, a memory 20, and a self-diagnosis apparatus 70. Also, the controller is equipped with either one or both an input/output device 50 and a communication apparatus group 60. The input/output device 50 is connected to an externally provided sensor and an externally provided actuator. The communication apparatus group 60 is provided with a communication function capable of being communicated with other control systems. These appliances are connected to each other by way of a system bus 40.

A diagnostic target device allocator 71 selects a diagnostic target apparatus from a diagnosable device list memory 711 in each of diagnostic cycles, and then, instructs a diagnostic executor 72 to diagnose this selected apparatus. The dianostic executor 72 executes a diagnosis in accordance with each of predetermined diagnostic sequences with respect to the instructed device among the input/output device 50 and the communication apparatus group 60 (will be referred to as “device” as a unified name hereinafter).

The interconnection operations between both the diagnostic target device allocator 71 and the diagnostic executor 72, and both the OS 21 and the control tasks Task-a, Task-b, - - - , can be executed in a similar manner to the previously explained sequence in FIG. 5. The OS 21 has contained management information as to devices under used in the respective control tasks Task-a, Task-b, - - - . When the OS 21 performs a task switching operation, the OS 21 investigates such a device which is used in a control task after the task switching operation has been carried out, and passes to the diagnostic target device allocator 71, such a list of diagnosable devices which are obtained by removing these investigated device from a set of all devices. In the diagnostic target device allocator 71, the list of the diagnosable devices is held in the diagnosable device list memory 711, and the list of the diagnosable devices is segmented in the unit of a diagnosis, and then, the segmented diagnosable device list is transferred to the diagnostic executor 72, and this diagnostic executor 72 executes a diagnose. A device whose diagnose has been accomplished by the diagnostic executor 72 is stored in a diagnosed device management information memory 712, and also, this stored device is excluded from the diagnostic targets for a time period until the diagnosises have been accomplished with respect to all of the devices.

In accordance with the previously described embodiment 3, the device diagnosis can be carried out while escaping such a device which may be probably accessed by the control task under execution on the main processor 10. As a consequence, it is possible to avoid a delay of executions which occurs since the control task accesses the device under diagnose.

It should be further understood by those skilled in the art that although the foregoing description has been made on embodiments of the invention, the invention is not limited thereto and various changes and modifications may be made without departing from the spirit of the invention and the scope of the appended claims.

1. In a self-diagnosis system of a controller which is equipped with a memory connected to a system bus; a main processor connected to said system bus, for executing a control task by employing said memory; and an input/output device and/or a communication apparatus, which is connected to said system bus and is employed so as to input/output a signal by said main processor;
said self-diagnosis system of the controller, comprising:
a diagnostic target area allocator for allocating a structural element of said controller as a diagnosis-ready area, which is not used in a control task under execution by said main processor, in an independent manner from said main processor; and
a diagnostic executor for executing a diagnosis based upon a predetermined sequence with respect to the diagnosis-ready area allocated by said diagnostic target area allocator in an independent manner from said main processor.

2. A self-diagnosis system of a controller as claimed in claim 1 wherein:
when said structural element of said controller which should be diagnosed is said memory, said diagnostic target area allocator is comprised of: means for setting a remaining memory area as the diagnosis-ready area, from which an area used by the control task under execution is removed.

3. A self-diagnosis system of a controller as claimed in claim 1 wherein:
when said structural element of said controller which should be diagnosed is said memory, said self-diagnosis system is further comprised of an alternative memory for saving a content of a specific area within said memory, and also which can be accessed from said main processor.

4. A self-diagnosis system of a controller as claimed in claim 1 wherein:
when said structural element of said controller which should be diagnosed is said memory, said diagnostic target area allocator is arranged in such a manner that information related to an area within said memory which is not used in a control task under execution by said main processor is acquired from an OS (operating system) within said memory.

5. A self-diagnosis system of a controller as claimed in claim 1 wherein:
when said structural element of said controller which should be diagnosed is said input/output device and/or said communication apparatus group, said diagnostic target area allocator is comprised of: means for setting a remaining input/output device and/or a remaining communication apparatus group as the diagnosis-ready area, from which an apparatus used by a control task under execution is removed.

6. A self-diagnosis system of a controller as claimed in claim 1 wherein:
said diagnostic target area allocator is comprised of: segmenting/transferring means for segmenting said diagnosis-ready area to pages in a diagnostic unit and for transferring the segmented pages to said diagnostic executor.

7. A self-diagnosis system of a controller as claimed in claim 1 wherein:
said diagnostic target area allocator is comprised of: diagnostic target area managing means for recording a diagnosed area; and means for excluding such a diagnosis-ready area which has already been recorded in said diagnostic target area managing means as the diagnosed area among said diagnosis-ready areas from the diagnostic targets.

8. A self-diagnosis system of a controller as claimed in claim 7 wherein:
said diagnostic target area managing means is comprised of: updating means for clearing the recorded area which has already been diagnosed when all areas of said memory have already been diagnosed.

9. A self-diagnosis system of a controller as claimed in claim 1 wherein:
said diagnostic executor for executing the diagnosis based upon said predetermined sequence includes an auxiliary processor which is operated independent from said main processor.

10. A self-diagnosis system of a controller which is equipped with a memory connected to a system bus; a main processor connected to said system bus, for executing a control task by employing said memory; and a diagnosing apparatus connected to said system bus, for diagnosing said memory in an independent manner from said main processor; wherein:
said diagnosing apparatus is comprised of:
a diagnostic target area allocator for allocating a memory area of said memory as a diagnosis-ready area, which is not used in a control task under execution by said main processor; and
a diagnostic executor for executing a diagnosis based upon a predetermined sequence with respect to said diagnosis-ready area.

11. A self-diagnosis system of a controller as claimed in claim 10 wherein:
said self-diagnosis system is further comprised of: an alternative memory for storing thereinto information which is saved from a specific area within said memory, and which can be accessed from said main processor.

12. A self-diagnosis system of a controller as claimed in claim 10 wherein:
said diagnostic target area allocator is arranged in such a manner that information related to an area within said memory which is not used in a control task under execution by said main processor is acquired from an OS (operating system) within said memory.

13. A self-diagnosis system of a controller as claimed in claim 10 wherein:
said diagnostic target area allocator is comprised of: segmenting/transferring means for segmenting said diagnosis-ready area to pages in a diagnostic unit and for transferring the segmented pages to said diagnostic executor.

14. A self-diagnosis system of a controller as claimed in claim 10 wherein:
said diagnostic target area allocator is comprised of: diagnostic target area managing means for recording a diagnosed area; and means for excluding such a diagnosis-ready area which has already been recorded in said diagnostic target area managing means as the diagnosed area among said diagnosis-ready areas from the diagnostic targets.

15. A self-diagnosis system of a controller as claimed in claim 14 wherein:
said diagnostic target area managing means is comprised of: updating means for clearing the recorded area which has already been diagnosed when all areas of said memory have already been diagnosed.

16. A self-diagnosis system of a controller as claimed in claim 10 wherein:
said diagnostic executor for executing the diagnosis based upon said predetermined sequence includes an auxiliary processor which is operated independent from said main processor.

17. In a self-diagnosis method of a controller which is equipped with a memory connected to a system bus; and a main processor connected to said system bus, for executing a control task by employing said memory;
said self-diagnosis method comprising:
a diagnostic target area allocating step for allocating a memory area of said memory as a diagnosis-ready area independent of said main processor which is not used in a control task under execution by said main processor; and
a diagnostic executing step for executing a diagnosis based upon a predetermined sequence with respect to said diagnosis-ready area independent of said main processor.

18. A self-diagnosis method of a controller as claimed in claim 17, further comprising:
a step for storing information saved from a specific area within said memory; and
a step for causing said main processor to access said alternative memory instead of said specific area of said memory.

19. A self-diagnosis method of a controller as claimed in claim 17 wherein:
said diagnostic target area allocating step is comprised of:
a step for acquiring from an OS within said memory, such an information related to an area within said memory, which is not used in a control task under execution by said main processor; and
a step for segmenting the acquired information related to the area within the memory in the unit of a diagnostic execution to transfer the segmented information to said diagnostic executing step.

20. A self-diagnosis method of a controller as claimed in claim 17 wherein:
said diagnostic target area allocating step is comprised of:
a diagnostic target area managing step for storing an area, the diagnose of which has been accomplished; and
a step for excluding from a diagnostic subject, said area stored in said diagnostic target area managing step as such an area whose diagnosis has been accomplished within said diagnosis-ready area.
